(19) United States
(12) Patent Application Publication
(10) Pub. No.: US 2011/0219290 A1
(43) Pub. Date: Sep. 8, 2011

(54) System For And Method Of Providing Enhanced Content Navigation On A Reader Device

(75) Inventors: William Leshner, San Diego, CA (US); Brady Duga, Carlsbad, CA (US); Garth Conboy, La Jolla, CA (US); John Rivlin, Palo Alto, CA (US)

(73) Assignees: SKIFF, LLC, New York, NY (US); eBook Technologies, Inc., La Jolla, CA (US)

(21) Appl. No.: 12/718,304

(22) Filed: Mar. 5, 2010

(51) Int. Cl. G06F 15/16; G06F 17/00

(52) U.S. Cl. 715/205; 709/217

(57) ABSTRACT

A system for and method of providing enhanced content navigation on an electronic device in accordance with exemplary embodiments may include identifying electronic content to be displayed on the electronic device, embedding, in the electronic content, a navigation link that initiates a navigation action when activated at the electronic device, and transmitting, to the electronic device, the electronic content that comprises the navigation link via a network.

### FIELD OF THE INVENTION

The present invention relates to content navigation, generally, and a system for and method of providing enhanced content navigation on a reader device, in particular.

### BACKGROUND INFORMATION

In general, paper-based distribution of print media content (e.g., newspapers, magazines) may become obsolete in the near future. Many print media companies may begin to distribute such print media content electronically using reader devices in an attempt to remain competitive. In many cases, however, these reader devices may be configured to display a portion of the electronic print media content to end-users.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 illustrates a block diagram of an enhanced content creation system according to an embodiment of the invention;

FIG. 2 illustrates exemplary modules of a content creation system according to an embodiment of the invention;

FIG. 3 illustrates exemplary modules of a reader device according to an embodiment of the invention;

FIG. 4A illustrates an example diagram of a reader device initiating a navigation action according to an embodiment of the invention;

FIG. 4B illustrates an example diagram of a reader device initiating another navigation action according to an embodiment of the invention;

FIG. 4C illustrates an example diagram of a reader device initiating another navigation action according to an embodiment of the invention;

FIG. 5 is a flow chart illustrating a method of providing enhanced content navigation on a reader device according to an embodiment of the invention; and

FIG. 6 is a flow chart illustrating another method of providing enhanced content navigation on a reader device according to an embodiment of the invention.

### SUMMARY OF EMBODIMENTS OF THE INVENTION

At least one exemplary embodiment may provide a method for providing enhanced content navigation on an electronic device. This embodiment may include identifying electronic content to be displayed on the electronic device, embedding, in the electronic content, a navigation link that initiates a navigation action when activated at the electronic device, and transmitting, to the electronic device, the electronic content that comprises the navigation link via a network.

Another exemplary embodiment according to this invention may provide a system for providing enhanced content navigation on an electronic device. This embodiment may include a content layout computing apparatus configured to identify electronic content to be displayed on the electronic device and embed, in the electronic content, a navigation link that initiates a navigation action when activated at the electronic device and a communication computing apparatus configured to transmit, to the electronic device, the electronic content that comprises the navigation link via a network.

Another exemplary embodiment according to this invention may provide a method for providing enhanced content navigation on an electronic device. This embodiment may include receiving, from a content creation system, electronic content that comprises a navigation link via a network, activating the navigation link in response to one or more inputs from a user of the electronic device, and initiating a navigation action based on the activated navigation link.

Another exemplary embodiment according to this invention may provide a system for providing enhanced content navigation on an electronic device. This embodiment may include a communication computing apparatus configured to receive, from a content creation system, electronic content that comprises a navigation link via a network, an user interface computing apparatus configured to activate the navigation link in response to one or more inputs from a user of the electronic device, and a navigation link activation computing apparatus configured to initiate a navigation action based on the activated navigation link.

### DETAILED DESCRIPTION OF EMBODIMENTS OF THE INVENTION

A reader device may display a portion of electronic content (e.g., perishable content, web-based content, electronic newspapers, electronic magazines) to a user on a display screen (e.g., an electrophoretic display (EPD) screen, a plasma display screen, a liquid crystal display (LCD) screen) at any given time. Using current navigation techniques, the user of the reader device may cause the reader device to zoom in on a particular portion of the electronic content, zoom out to view a greater portion of the electronic content, scroll up or down to view additional portions of the electronic content, and/or turn pages to view additional portions of the electronic content. Such basic navigation features, however, fail to provide the user of the reader device with a rich interaction experience. Accordingly, an enhanced content creation system may generate more “active” electronic content to increase the navigation abilities of a reader device.

An enhanced content creation system may allow a user to navigate electronic content stored on a reader device using one or more enhanced navigation features. The enhanced content creation system may communicatively couple one or more reader devices to a content creation system using a data network (e.g., a broadcast network, a cellular network, a content distribution network (CDN)). In one embodiment, the content creation system may be configured to prepare and transmit “active” electronic content to the one or more reader devices using the data network.

Prior to transmitting the electronic content, the content creation system may embed one or more navigation links into the electronic content to generate “active” electronic content. A navigation link may include a hyperlink that is configured to operate in accordance with an action protocol associated with a particular markup language (e.g., hypertext markup language (HTML), extensible markup language (XML)) or any other language used to encode electronic documents. An action protocol may include a set of one or more rules that govern the performance of an action (e.g., a navigation action). In one embodiment, the content creation system may embed the one or more navigation links into the electronic content by placing the navigation links on one or more pages of the electronic content.

Based on the “active” electronic content received, the reader device may display electronic content with one or more embedded navigation links to a user on a display screen. In response to input from a user of the reader device, the reader device may activate an embedded navigation link. That is, the reader device may initiate a navigation action associated with a navigation link in response to user input (e.g., a user clicking on the navigation link). Accordingly, the activated navigation link may initiate the performance of a navigation action by the reader device.

A navigation action may include the performance of any steps associated with navigating to one or more portions of electronic content stored on a reader device or one or more spaces (e.g., a game space that allows a user to play a game, a web space that allows a user to access the Web) supported by a reader device. In one embodiment, a navigation action may include navigating from a first portion of electronic content (e.g., page 4 of a newspaper article) to a second portion of the electronic content (e.g., the final page of the newspaper article). In another embodiment, a navigation action may include navigating from electronic content to a space supported by a reader device (e.g., a game space, a web space). In another embodiment, a navigation action may include displaying a navigation tray that lists one or more portions of electronic content to which a user can navigate. In another embodiment, a navigation action may include displaying a search tray in which a user can enter search criteria.

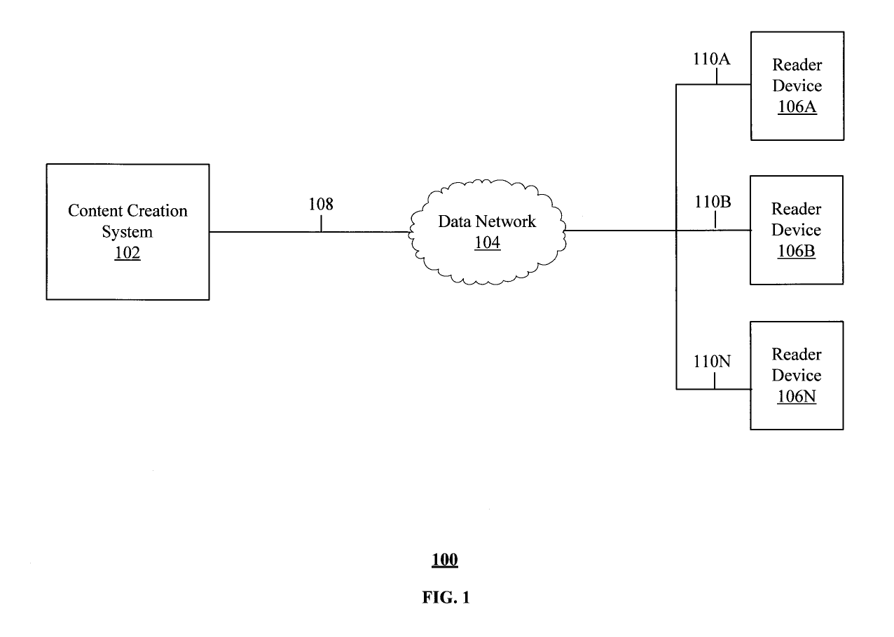

FIG. 1 illustrates a block diagram of an enhanced content creation system according to an embodiment of the invention. In one embodiment, an enhanced content creation system 100 may communicatively couple any, or a combination, of a content creation system 102 and reader devices 106A, 106B, 106N using any, or a combination, of data network 104 and data paths 108, 110A, 110B, 110N. Accordingly, data signals may be transmitted to any of the components of the enhanced content creation system 100 and transmitted from any of the components of the enhanced content creation system 100 using any, or a combination, of data network 104 and data paths 108, 110A, 110B, 110N. For example, electronic content data signals, navigation link data signals, or any other data signals may be transmitted to any of the components of the enhanced content creation system 100 and transmitted from any of the components of the enhanced content creation system 100 using any, or a combination, of data network 104 and data paths 108, 110A, 110B, 110N.

The data network 104 may be a wireless network, a wired network, or any combination of wireless network and wired network. For example, the data network 104 may include any, or a combination, of a fiber optics network, a passive optical network, a radio near field communication network (e.g., a Bluetooth network), a cable network, an Internet network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network configured to transmit or receive a data signal. In addition, the data network 104 may include, without limitation, a telephone line, fiber optics, IEEE Ethernet 802.3, a wide area network (WAN), a LAN, or a global network, such as the Internet. Also, the data network 104 may support, an Internet network, a wireless communication network, a cellular network, a broadcast network, or the like, or any combination thereof. The data network 104 may further include one, or any number of the exemplary types of networks mentioned above operating as a stand-alone network or in cooperation with each other. The data network 104 may utilize one or more protocols of one or more network elements to which it is communicatively coupled. The data network 104 may translate to or from other protocols to one or more protocols of network devices. Although the data network 104 is depicted as one network, it should be appreciated that according to one or more embodiments, the data network 104 may comprise a plurality of interconnected networks, such as, for example, a service provider network, the Internet, a broadcaster's network, a cable television network, corporate networks, and home networks. The data network 104 may be configured to perform the functions of the content distribution network described in U.S. patent application Ser. No. 12/248,482 entitled “Systems, Methods And Apparatus For Content Distribution,” filed on Oct. 9, 2008, which is incorporated by reference herein in its entirety.

The content creation system 102 and reader devices 106A, 106B, 106N may transmit data to and receive data from the data network 104. The data may be transmitted and received utilizing a standard telecommunications protocol or a standard networking protocol. For example, one embodiment may utilize Session Initiation Protocol (SIP). In other embodiments, the data may be transmitted, received, or a combination of both, utilizing other VoIP or messaging protocols. For example, data may also be transmitted, received, or a combination of both, using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wire-line connection, a cable connection, or other wired network connection. The data network 104 may use standard wireless protocols including IEEE 802.11a, 802.11b, 802.11g, and 802.11n. The data network 104 may also use protocols for a wired connection, such as an IEEE Ethernet 802.3.

The content creation system 102 may be communicatively coupled to data network 104 via data path 108. The content creation system 102 may include, but is not limited to, a computer device or communications device. For example, the content creation system 102 may include a personal computer (PC), a workstation, a mobile device, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other device that is configured to identify electronic content to be transmitted to reader devices 106A, 106B, 106N, embed the electronic content with one or more navigation links by placing the navigation links on one or more pages of the electronic content, and transmit the electronic content with one or more embedded navigation links to reader devices 106A, 106B, 106N. Details of the content creation system 102 are provided below.

The reader devices 106A, 106B, 106N may be communicatively coupled to data network 104 via data paths 110A, 110B, 110N, respectively. In one embodiment, the reader devices 106A, 106B, 106N may be configured to display electronic content to an end-user (e.g., subscriber) using a display screen (e.g., an electrophoretic display screen, a plasma screen, a Liquid Crystal Display (LCD) screen). The functionalities of the reader devices 106A, 106B, 106N may include those described in U.S. patent application Ser. No. 12/248,331 entitled “Media Display Device And Method Of Operation Thereof,” filed on Oct. 9, 2008, which is incorporated by reference herein in its entirety.

Any electronic device having a display that can render electronic content or images may be used. In one embodiment, reader device 106 may be an electronic reading device. Examples of electronic reading devices include electronic book readers, electronic newspaper readers, electronic paper readers, etc. Examples of an electronic display device are disclosed in U.S. patent application Ser. No. 12/481,677 entitled “Flexible Electronic Device And Method Of Manufacture”; U.S. patent application Ser. No. 12/248,331 entitled “Foldable Media Device”; U.S. patent application Ser. No. 12/332,860 entitled “Touch Sensitive Illuminated Display”; U.S. patent application Ser. No. 12/549,785 entitled “Thin Reader Device”; and U.S. patent application Ser. No. 12/574,721 entitled “Always On Reader Device.” The disclosure of each of these patent applications is incorporated, by reference, it its entirety.

Other examples of electronic reading devices include the Amazon Kindle, the Sony Reader, the Plastic Logic Reader, and the iRex iLiad electronic reader. Other examples of electronic devices include computers (e.g., desktops, notebooks, laptops, tablets, web books, net books), personal digital assistants (PDAs), digital cameras, digital picture frames, music players, portable video players, video game players, telephones, mobile telephones, etc.

Other related disclosures include U.S. Patent Application No. 60/978,748 entitled “Content Distribution And Preloading”; U.S. patent application Ser. No. 12/481,336 entitled “System And Method For Providing Spatial And Temporal Content In An Electronic Device”; U.S. patent application Ser. No. 12/481,705 entitled “System And Method For Providing Sub-Publication Content In An Electronic Device”; U.S. patent application Ser. No. 12/481,306 entitled “Electronic Paper Display Device Event Tracking”; U.S. patent application Ser. No. 12/481,365 entitled “System And Method For Delivering Publication Content To Reader Devices Using Mixed Mode Transmission”; U.S. patent application Ser. No. 12/575,009 entitled “Electronic Advertisement Placement”; and U.S. patent application Ser. No. 12/639,512 entitled “System And Method For Rendering Advertisements On An Electronic Device.” The disclosure of each of these patent applications is incorporated, by reference, in its entirety.

The reader devices 106A, 106B, 106N may be configured to receive the electronic content with one or more embedded navigation links from the content navigation system 102. Based on input from a user, reader devices 106A, 106B, 106N may activate a navigation link embedded in the electronic content displayed. In response to the activated navigation link, reader devices 106A, 106B, 106N may initiate a navigation action that is associated with the activated navigation link. Details of reader devices 106A, 106B, 106N are provided below.

The data paths disclosed herein may include any device that communicatively couples devices to each other. For example, a data path may include one or more networks or one or more conductive wires (e.g., copper wires).

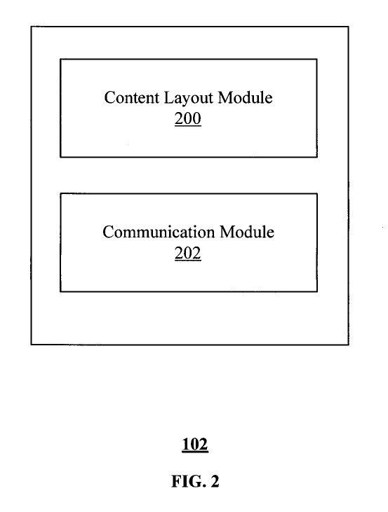

FIG. 2 illustrates exemplary modules of a content creation system according to an embodiment of the invention. In an exemplary embodiment, the content creation system 102 may include a content layout module 200 and a communication module 202. It is noted that modules 200 and 202 are exemplary. The functions of modules 200 and 202 may be performed at other modules remote or local to the content creation system 102, and modules 200 and 202 may be combined or separated. Other modules may be provided as necessary and/or desired.

The content layout module 200 may include any, or a combination, of software and hardware that may be configured to identify electronic content to be transmitted to and displayed on a reader device. In one embodiment, the content layout module 200 may identify electronic content to be displayed on a particular reader device based on one or more subscriptions held by a user of the reader device. For example, the content layout module 200 may identify first electronic content (e.g., an electronic version of the September 2009 issue of the Cosmopolitan magazine) to be transmitted to and displayed on a first reader device based on a first user's subscription (e.g., an active subscription to receive the Cosmopolitan magazine). In another example, the content layout module 200 may identify second electronic content (e.g., an electronic version of the Connecticut Post newspaper) to be transmitted to and displayed on a second reader device based on a second user's subscription (e.g., an active subscription to receive the Connecticut Post newspaper). In yet another example, the content layout module 200 may identify third electronic content (e.g., an electronic version of the January 2010 issue of the O, The Oprah Magazine) to be transmitted to and displayed on a third reader device based on a third user's subscription (e.g., an active subscription to receive the O, The Oprah Magazine).

In another embodiment, the content layout module 200 may identify electronic content to be displayed on one or more reader devices based on the type of electronic content. For example, the content layout module 200 may identify general electronic content (e.g., general electronic content that is not limited to subscribing users) to be transmitted to and displayed on one or more reader devices communicatively coupled to the content creation system 102. In another example, the content layout module 200 may identify electronic content directed to one or more reader devices registered or located in a particular geographic region (e.g., one or more reader devices registered or located in the state of New York).

The content layout module 200 may include any, or a combination, of software and hardware that may be configured to embed one or more navigation links in the identified electronic content. In one embodiment, the content layout module 200 may perform one or more error checking techniques on the embedded navigation links in the identified electronic content. An error checking technique may include the performance of one or more steps to ensure that a an embedded navigation link will activate properly on a reader device in response to user input.

In another embodiment, the content layout module 200 may embed navigation links in the identified electronic content by placing the navigation links on one or more pages of the electronic content. Each navigation link may be associated with a navigation action. For example, a navigation link may be associated with a navigation action that includes navigating from a first portion of identified electronic content (e.g., page 4 of a newspaper article) to a second portion of the identified electronic content (e.g., the final page of the newspaper article). In another example, a navigation link may be associated with a navigation action that includes navigating from identified electronic content to a space supported by a reader device (e.g., a game space, a web space). In another example, a navigation link may be associated with a navigation action that includes displaying a navigation tray that lists one or more portions of electronic content to which a user can navigate. In yet another example, a navigation link may be associated with a navigation action that includes displaying a search tray in which a user can enter search criteria.

The placement of a navigation link on a particular page of the identified electronic content may be determined based on design preferences or user preferences. For example, the implementers of the enhanced content creation system 100 may determine to place a navigation link associated with a navigation action that initiates a game supported by a game space on a page of the identified electronic content that references the game. In another example, the implementers of the enhanced content creation system 100 may determine to place a navigation link associated with a navigation action that displays a navigation tray that lists one or more portions of electronic content to which a user can navigate on a page of identified electronic content (e.g., a long magazine article on US history).

It should be noted that the content layout module 200 may create multiple layouts of electronic content to account for the multiple zoom states of the electronic content. A zoom state may include a particular state of the electronic content that is defined by an amount the electronic content is expanded (e.g., zoom in) or contracted (e.g., zoom out).

The communication module 202 may include any, or a combination, of software and hardware that may be configured to transmit electronic content data and navigation link data to one or more reader devices via data path 108 and data network 104. The communication module 202 may include any, or a combination, of software and hardware configured to communicate data received to one or more other modules of the content creation system 102, such as the content layout module 200. In one embodiment, the communication module 202 may be configured to communicate one or more messages received from one module to one or more other modules.

It should be noted that any of the functions performed by the content creation system 102 may be performed by a reader device (e.g., reader device 106). For example, the reader device may be configured to perform one or more error checking techniques.

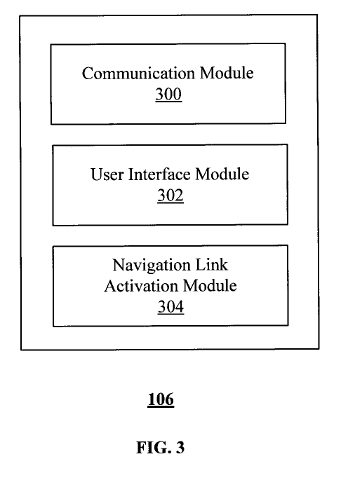

FIG. 3 illustrates exemplary modules of a reader device according to an embodiment of the invention. In an exemplary embodiment, the reader devices 106A, 106B, 106N may include a communication module 300, a user interface module 302, and a navigation link activation module 304. It is noted that modules 300, 302, and 304 are exemplary. The functions of modules 300, 302, and 304 may be performed at other modules remote or local to the reader devices 106A, 106B, 106N, and modules 300, 302, and 304 may be combined or separated. Other modules may be provided as necessary and/or desired.

The communication module 300 may include any, or a combination, of software and hardware that may be configured to receive electronic content data that includes navigation link data from the content creation system 102 via data path 110 and data network 104. The communication module 300 may include any, or a combination, of software and hardware configured to communicate the electronic content data and the navigation link data received to one or more other modules, such as: the user interface module 302 and the navigation link activation module 304. In one embodiment, the communication module 302 may be configured to communicate one or more messages received from one module to one or more other modules.

The navigation link activation module 304 may include any, or a combination, of software and hardware that may be configured to activate a navigation link associated with displayed electronic content in response to one or more user inputs. In one embodiment, the navigation link activation module 304 may be configured to activate the navigation link in response to a user “touching” the navigation link (e.g., the user clicking on the navigation link). In another embodiment, the navigation link activation module 304 may be configured to activate the navigation link in response to a user “highlighting” the navigation link (e.g., the user using a input device to highlight the navigation link and pressing an enter button).

The navigation link activation module 304 may include any, or a combination, of software and hardware that may be configured to initiate and perform a navigation action based on the activated navigation link. In one embodiment, the navigation link activation module 304 may initiate and perform a navigation action by navigating from a first portion of the displayed electronic content (e.g., first page of an electronic newspaper article) to a second portion of the displayed electronic content (e.g., last page of the electronic newspaper article). In another embodiment, the navigation link activation module 304 may initiate and perform a navigation action by navigation from the displayed electronic content (e.g., an electronic magazine article) to a space supported by a reader device (e.g., a game space, a web space). In another embodiment, the navigation link activation module 304 may initiate and perform a navigation action by displaying a navigation tray that lists one or more portions of the displayed electronic content to which a user can navigate. In yet another embodiment, the navigation link activation module 304 may initiate and perform a navigation action by displaying a search tray that enables a user to enter search criteria.

The user interface module 302 may include any, or a combination, of software and hardware that may be configured to display the received electronic content and the one or more navigation links associated with the electronic content on any screen coupled to the reader devices 106A, 106B, 106N. For example, the screen may be an EPD display, a plasma display, a LCD display, an eInk display, etc. In one embodiment, the user interface module 302 may be configured to receive user input that activates one or more navigation links and/or activate the one or more navigation links based on the user input.

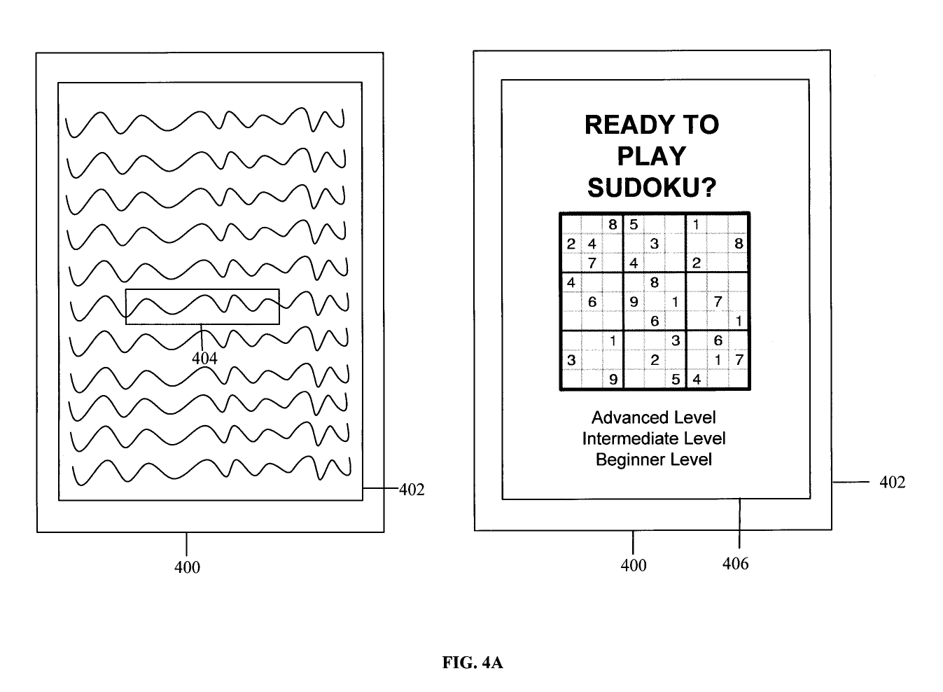

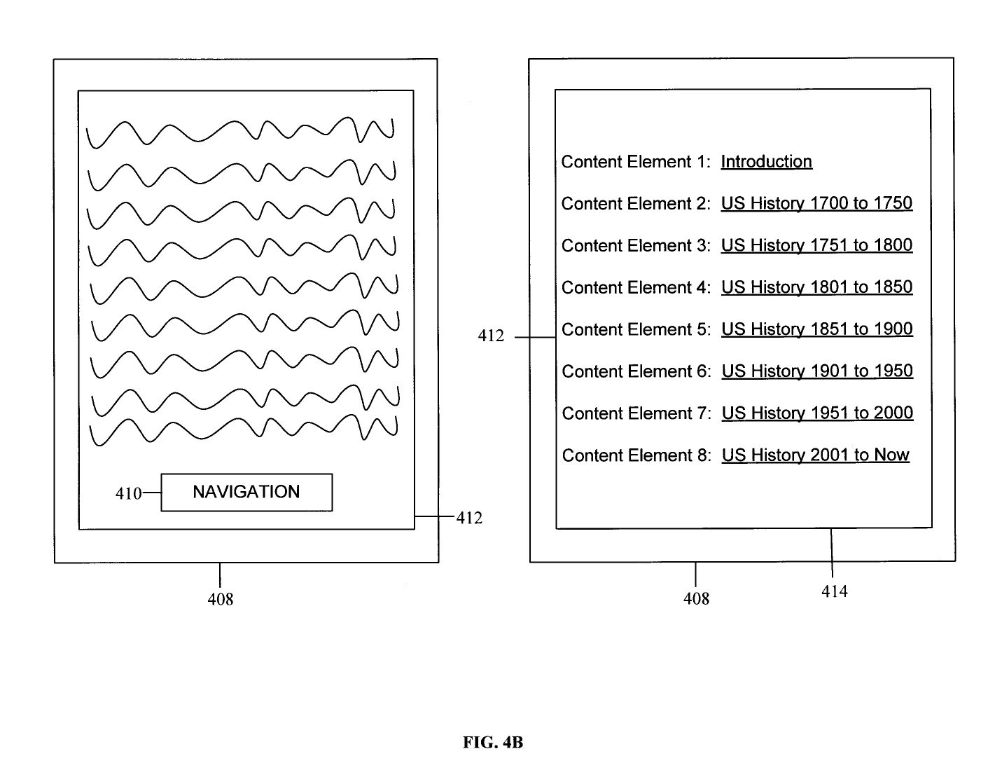

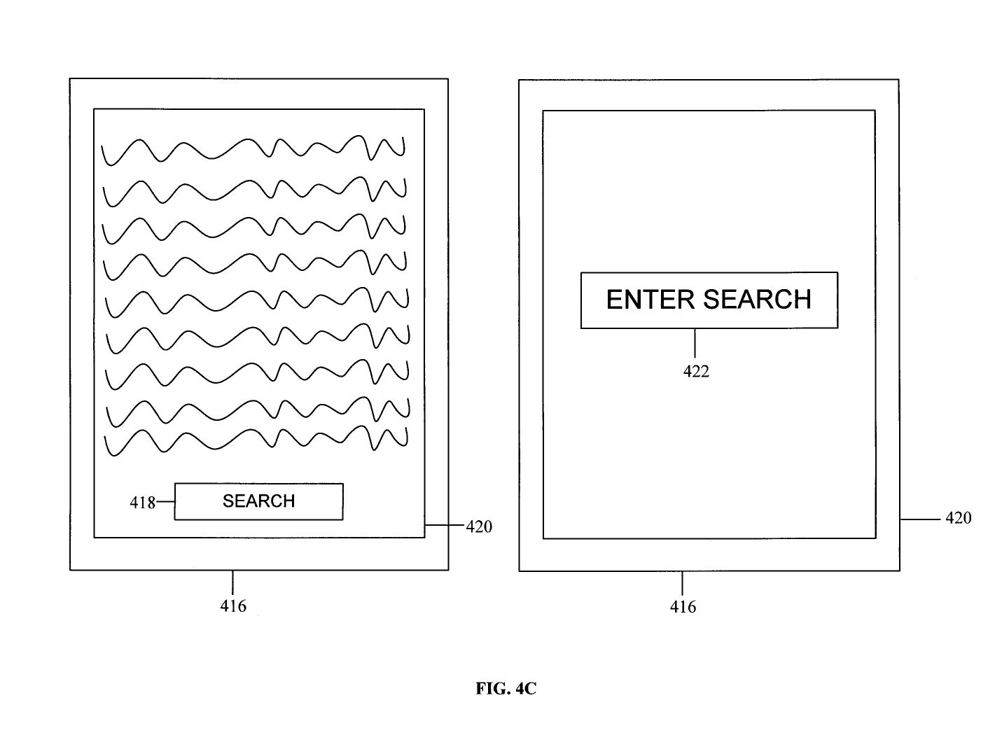

FIG. 4A illustrates an example diagram of a reader device initiating a navigation action according to an embodiment of the invention. As illustrated in FIG. 4A, a reader device 400 may display electronic content on a display screen 402 coupled to the reader device 400. The electronic content displayed on the display screen 402 of the reader device 400 may include one or more embedded navigation links, such as embedded navigation link 404. In response to user input, the reader device 400 may activate the embedded navigation link 404 by initiating the performance of a navigation action associated with the embedded navigation link 404.

As shown, the reader device 400 may initiate a navigation action that includes navigating to a game space supported by the reader device 400, such as a “Sudoku” game space 406. Accordingly, a user of the reader device 400 may begin to play the “Sudoku” game in the game space that has been initiated.

FIG. 4B illustrates an example diagram of a reader device initiating another navigation action according to an embodiment of the invention. As illustrated in FIG. 4B, a reader device 408 may display electronic content on a display screen 412 coupled to the reader device 408. The electronic content displayed on the display screen 412 of the reader device 408 may include one or more embedded navigation links, such as embedded navigation link 410. In response to user input, the reader device 408 may activate the embedded navigation link 410 by initiating the performance of a navigation action associated with the embedded navigation link 410.

As shown, the reader device 408 may initiate a navigation action that includes displaying a navigation tray 414 that lists one or more portions of the electronic content to which a user may navigate. For example, in response to receiving additional user inputs, the reader device 408 may navigate to the “Content Element 1: Introduction” portion of the displayed electronic content. In another example, in response to receiving additional user inputs, the reader device 408 may navigate to the “Content Element 2: US History 1700 to 1750” portion of the displayed electronic content. In another example, in response to receiving additional user inputs, the reader device 408 may navigate to the “Content Element 3: US History 1751 to 1800” portion of the displayed electronic content. In another example, in response to receiving additional user inputs, the reader device 408 may navigate to the “Content Element 4: US History 1801 to 1850” portion of the displayed electronic content. In another example, in response to receiving additional user inputs, the reader device 408 may navigate to the “Content Element 5: US History 1851 to 1900” portion of the displayed electronic content. In another example, in response to receiving additional user inputs, the reader device 408 may navigate to the “Content Element 6: US History 1901 to 1950” portion of the displayed electronic content. In another example, in response to receiving additional user inputs, the reader device 408 may navigate to the “Content Element 7: US History 1951 to 2000” portion of the displayed electronic content. In yet another example, in response to receiving additional user inputs, the reader device 408 may navigate to the “Content Element 8: US History 2001 to Now” portion of the displayed electronic content.

FIG. 4C illustrates an example diagram of a reader device initiating another navigation action according to an embodiment of the invention. As illustrated in FIG. 4C, a reader device 416 may display electronic content on a display screen 420 coupled to the reader device 416. The electronic content displayed on the display screen 420 of the reader device 416 may include one or more embedded navigation links, such as embedded navigation link 418. In response to user input, the reader device 416 may activate the embedded navigation link 418 by initiating the performance of a navigation action associated with the embedded navigation link 418.

As shown, the reader device 416 may initiate a navigation action that includes displaying a search tray 422 that enables a user of the reader device 416 to enter search criteria. The reader device 416 may search for the search criteria within the displayed electronic content and return results of the search to the user. Based on the results returned, the user of the reader device 416 may navigate to one or more portions of the displayed electronic content that are associated with the search results.

An embedded navigation link may be associated with the initiation and performance of any navigation action supported by the reader devices 106A, 106B, 106N. For example, a navigation action may include performing a “goto-location” action that includes navigating to a “next page” of the displayed electronic content, a “previous page” of the displayed electronic content, a “first page” of the displayed electronic content, a “last page” of the displayed electronic content, or a particular page of the displayed electronic content based on input from the user of the reader device. In another example, a navigation action may include performing an “open book” action that includes navigating to other electronic content stored on the reader device based on input from the user of the reader device. In another example, a navigation action may include performing a “local-book-list” action that includes navigating to a list of electronic content locally stored on the reader device. In another example, a navigation action may include performing a “home” action that includes navigating to a “home” page of the reader device. In another example, a navigation action may include performing a “remote-book-list” action that includes navigating to a list of electronic content remotely stored and available to the reader device. In another example, a navigation action may include performing a “book-list” action that includes navigating to a list of electronic content locally stored and remotely stored. In yet another example, a navigation action may include performing a “web-space” action that includes navigating to a web space.

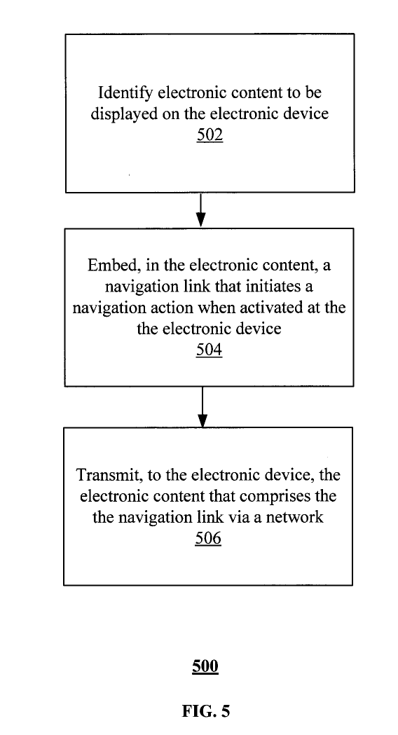

FIG. 5 is a flow chart illustrating a method of providing enhanced content navigation on a reader device according to an embodiment of the invention. This method is provided as an example; there are a variety of ways to carry out methods disclosed herein. The method 500 shown in FIG. 5 can be executed or otherwise performed by one or a combination of various systems. The method 500 is described below as carried out by the content creation system 102 shown in FIG. 1 by way of example, and various elements of the content creation system 102 are referenced in explaining the example method of FIG. 5. Each block shown in FIG. 5 represents one or more processes, methods, or subroutines carried in the method 500. Referring to FIG. 5, the method 500 may begin at block 502.

In block 502, the method 500 may include identifying electronic content to be displayed on a reader device. In one embodiment, the content layout module 200 of the content creation system 102 may identify electronic content to be displayed on a reader device. For example, the content layout module 200 may identify electronic content to be transmitted to and displayed on a reader device based on one or more subscriptions held by a user of the reader device. In another example, the content layout module 200 may identify electronic content to be transmitted to and displayed on a reader device based on a type of the electronic content (e.g., general electronic content, electronic content directed to reader devices registered or located in a particular geographic region). The method 500 may continue to block 504.

In block 504, the method 500 may include embedding a navigation link that initiates a navigation action in the electronic content. In one embodiment, the content layout module 200 of the content creation system 102 may embed a navigation link that initiates a navigation action in the electronic content. Embedding a navigation link may include placing the navigation link on one or more pages of the electronic content. The method 500 may continue to block 506.

In block 506, the method 500 may include transmitting the electronic content that includes the navigation link to the reader device. In one embodiment, the communication module 202 of the content creation system 102 may transmit the electronic content and the navigation link to the reader device via data path 108 and data network 104. The method 500 may then end.

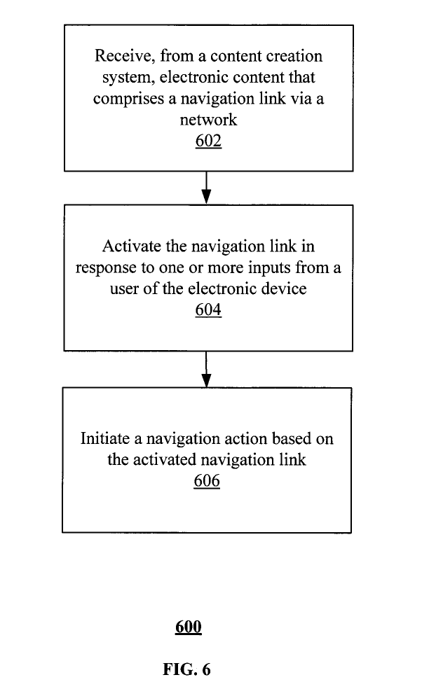

FIG. 6 is a flow chart illustrating another method of providing enhanced content navigation on a reader device according to an embodiment of the invention. This method is provided as another example; there are a variety of ways to carry out methods disclosed herein. The method 600 shown in FIG. 6 can be executed or otherwise performed by one or a combination of various systems. The method 600 is described below as carried out by the reader devices 106A, 106B, 106N shown in FIG. 1 by way of example, and various elements of the reader devices 106A, 106B, 106N are referenced in explaining the example method of FIG. 6. Each block shown in FIG. 6 represents one or more processes, methods, or subroutines carried in the method 600. Referring to FIG. 6, the method 600 may begin at block 602.

In block 602, the method 600 may include receiving electronic content that includes a navigation link from a content creation system via a network. In one embodiment, the communication module 300 of the reader device 106 may receive electronic content that includes a navigation link from the content creation system 102 via data path 110 and data network 104. The method 600 may continue to block 604.

In block 604, the method 600 may include activating the navigation link in response to one or more user inputs from a user of the reader device. In one embodiment, the user interface module 302 of the reader device 106 may activate the navigation link in response to one or more user inputs from a user of the reader device. The method 600 may continue to block 606.

In block 606, the method 600 may include initiating a navigation action based on the activated navigation link. In one embodiment, the navigation link activation module 304 of the reader device 106 may initiate a navigation action based on the activated navigation link. The method 600 may then end.

The description above describes systems, networks, and reader devices, that may include one or more modules, some of which are explicitly shown in the figures. As used herein, the term “module” may be understood to refer to any, or a combination, of computer executable software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein is tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

1. A computer-implemented method for providing enhanced content navigation on an electronic device operating on a programmed computer, the computer-implemented method comprising:
identifying electronic content to be displayed on the electronic device;
embedding, in the electronic content, a navigation link that initiates a navigation action when activated at the electronic device; and
transmitting, to the electronic device, the electronic content that comprises the navigation link via a network.

2. The computer-implemented method of claim 1, wherein embedding further comprises placing the navigation link on a page of the electronic content.

3. The computer-implemented method of claim 1, wherein the navigation link comprises a hyperlink configured to operate in accordance with an action protocol.

4. The computer-implemented method of claim 1, wherein the navigation action comprises navigating from the electronic content to a space supported by the electronic device.

5. The computer-implemented method of claim 1, wherein the navigation action comprises displaying a navigation tray that lists one or more portions of the electronic content.

6. The computer-implemented method of claim 1, wherein the navigation action comprises displaying a search tray.

7. The computer-implemented method of claim 1, wherein the network comprises a content distribution network (CDN).

8. A computer-implemented system for providing enhanced content navigation on an electronic device, the computer-implemented system comprising:
a content layout computing apparatus configured to identify electronic content to be displayed on the electronic device and embed, in the electronic content, a navigation link that initiates a navigation action when activated at the electronic device; and
a communication computing apparatus configured to transmit, to the electronic device, the electronic content that comprises the navigation link via a network.

9. The computer-implemented system of claim 8, wherein the content layout computing apparatus is further configured to embed the navigation link by placing the navigation link on a page of the electronic content.

10. The computer-implemented system of claim 8, wherein the navigation link comprises a hyperlink configured to operate in accordance with an action protocol.

11. The computer-implemented system of claim 8, wherein the navigation action comprises navigating from the electronic content to a space supported by the electronic device.

12. The computer-implemented system of claim 8, wherein the navigation action comprises displaying a navigation tray that lists one or more portions of the electronic content.

13. The computer-implemented system of claim 8, wherein the navigation action comprises displaying a search tray.

14. The computer-implemented system of claim 8, wherein the network comprises a content distribution network (CDN).

15. A computer-implemented method for providing enhanced content navigation on an electronic device operating on a programmed computer, the computer-implemented method comprising:
receiving, from a content creation system, electronic content that comprises a navigation link via a network;
activating the navigation link in response to one or more inputs from a user of the electronic device; and
initiating a navigation action based on the activated navigation link.

16. The computer-implemented method of claim 15, wherein the navigation link comprises a hyperlink configured to operate in accordance with an action protocol.

17. The computer-implemented method of claim 15, wherein initiating the navigation action comprises navigating from the electronic content to a space supported by the electronic device.

18. The computer-implemented method of claim 15, wherein initiating the navigation action comprises displaying a navigation tray that lists one or more portions of the electronic content.

19. The computer-implemented method of claim 15, wherein initiating the navigation action comprises displaying a search tray.

20. The computer-implemented method of claim 15, wherein the network comprises a content distribution network (CDN).

21. A computer-implemented system of providing enhanced content navigation on an electronic device, the computer-implemented system comprising:
a communication computing apparatus configured to receive, from a content creation system, electronic content that comprises a navigation link via a network;
a user interface computing apparatus configured to activate the navigation link in response to one or more inputs from a user of the electronic device; and
a navigation link activation computing apparatus configured to initiate a navigation action based on the activated navigation link.

22. The computer-implemented system of claim 21, wherein the navigation link comprises a hyperlink configured to operate in accordance with an action protocol.

23. The computer-implemented system of claim 21, wherein the navigation link activation computing apparatus is further configured to initiate the navigation action by navigating from the electronic content to a space supported by the electronic device.

24. The computer-implemented system of claim 21, wherein the navigation link activation computing apparatus is further configured to initiate the navigation action by displaying a navigation tray that lists one or more portions of the electronic content.

25. The computer-implemented system of claim 21, wherein the navigation link activation computing apparatus is further configured to initiate the navigation action by displaying a search tray.

26. The computer-implemented system of claim 21, wherein the network comprises a content distribution network (CDN).
